(19) United States
(12) Patent Application Publication
(10) Pub. No.: US 2025/0350061 A1
(43) Pub. Date: Nov. 13, 2025

(54) Electrical Connector and Conductive Terminal Thereof

(71) Applicants: Dongguan Tarng Yu Electronics Co., Ltd., Dongguan City (CN); Tarng Yu Enterprise co., ltd., New Taipei City (TW)

(72) Inventors: TSUNG-CHI CHEN, New Taipei City (TW); MU-JUNG HUANG, New Taipei City (TW)

(21) Appl. No.: 19/199,268

(22) Filed: May 5, 2025

(30) Foreign Application Priority Data
May 8, 2024 (TW) 113204688

(51) Int. Cl. H01R 13/432; H01R 13/648

(52) U.S. Cl. CPC H01R 13/432; H01R 13/6485

(57) ABSTRACT

An electrical connector and a conductive terminal thereof are provided, wherein the conductive terminal is capable of being equipped with an insulation core to form the electrical connector. The conductive terminal comprises a terminal body and a terminal cantilever. The terminal cantilever can deform to lock onto the insulation core, and the terminal body can limit the degree of deformation of the terminal cantilever to prevent the terminal cantilever from undergoing excessive deformation during locking with the insulation core, thereby solving the problem of poor locking between miniaturized conductive terminals and insulation cores, and further improving the reliability of the electrical connector equipped with miniaturized conductive terminals.

### CROSS-REFERENCE TO RELATED APPLICATIONS

This application claims the priority of Republic of China Patent Application No. 113204688 filed on May 8, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to a miniaturized electrical connector and a conductive terminal thereof.

### Descriptions of the Related Art

In recent years, with the rapid development of electronic products and the demand for miniaturization, the miniaturization of conductive terminals has become a common trend. However, this miniaturization also brings certain challenges, one of which is that miniaturized conductive terminals are prone to deformation when locking onto insulation cores to form electrical connectors, resulting in poor locking between the miniaturized conductive terminals and the insulation cores, making it easy for the miniaturized conductive terminals of the electrical connectors to detach from the insulation cores, thereby causing poor reliability of the electrical connectors equipped with miniaturized conductive terminals.

In view of the foregoing, how to provide a conductive terminal capable of reducing the degree of deformation when the miniaturized conductive terminal locks onto the insulation core, thereby solving the problem of poor locking between the miniaturized conductive terminal and the insulation core and improving the reliability of the electrical connector equipped with the miniaturized conductive terminal, has become a technical issue that the industry is urgently striving to overcome.

### SUMMARY OF THE INVENTION

In view of the drawbacks of the prior art mentioned above, the present application provides A conductive terminal configured for use with an insulating core, the conductive terminal comprising: a terminal body comprising a terminal inner space, a terminal restricting structure, and a terminal notch structure, wherein the terminal notch structure communicates with the terminal inner space; and a terminal cantilever comprising a cantilever connecting end, a cantilever non-connecting end and a cantilever locking structure, wherein the terminal cantilever is connected to the terminal body at the cantilever connecting end, and the cantilever locking structure is disposed at the cantilever non-connecting end, allowing the terminal cantilever to be deformable on the terminal body to lock the cantilever locking structure to the insulating core; wherein the terminal restricting structure is located between the terminal cantilever and the terminal notch structure and is configured to restrict the deformation degree of the terminal cantilever, so as to prevent the cantilever locking structure from falling into the terminal inner space via the terminal notch structure and from affecting the locking between the cantilever locking structure and the insulating core.

Preferably, the conductive terminal said above, wherein the terminal restricting structure is a protruding structure on the terminal body.

Preferably, the conductive terminal said above, wherein the terminal restricting structure comprises a first terminal restricting substructure and a second terminal restricting substructure, and the first terminal restricting substructure and the second terminal restricting substructure are respectively located on two sides of the terminal notch structure and configured to respectively restrict the deformation degree of two sides of the cantilever locking structure.

Preferably, the conductive terminal said above, wherein the cantilever locking structure is located above the terminal notch structure.

Preferably, the conductive terminal said above, wherein the terminal body has two opposite sides, which are a terminal locking side and a terminal non-locking side, respectively, and the terminal body further comprises a terminal seam structure, wherein the cantilever locking structure is located at the terminal locking side, and the terminal seam structure is located at the terminal non-locking side.

Preferably, the conductive terminal said above, wherein the terminal body has two opposite sides, which are a terminal locking side and a terminal non-locking side, respectively, and the terminal body further comprises a terminal abutting structure, wherein the cantilever locking structure is located at the terminal locking side, and the terminal abutting structure is located at the terminal non-locking side and is configured to abut the insulating core, so as to prevent the locking between the cantilever locking structure and the insulating core from being released.

Preferably, the conductive terminal said above, further configured for mating with a conductive component, wherein the terminal body further comprises a terminal mating structure, a terminal frame-shaped guiding body and a terminal mating passage, and the terminal frame-shaped guiding body comprises a terminal frame-shaped guiding structure, wherein, the terminal frame-shaped guiding structure is configured to guide the conductive component through the terminal mating passage into the terminal inner space to mate with the terminal mating structure.

Preferably, the conductive terminal said above, wherein the terminal frame-shaped guiding body further comprises a discharge contact structure, and when the terminal frame-shaped guiding structure is guiding the conductive component, the discharge contact structure is configured to contact the conductive component to provide electrostatic discharge for the conductive component, wherein the timing of the discharge contact structure contacting the conductive component is earlier than the timing of the terminal mating structure mating with the conductive component.

Preferably, the conductive terminal said above, wherein the discharge contact structure is a protruding structure.

Additionally, this application further provides an electrical connector comprising: an insulating core comprising a core insertion passage and a core locking structure; and a conductive terminal comprising: a terminal body comprising a terminal inner space, a terminal restricting structure, and a terminal notch structure, wherein the terminal notch structure communicates with the terminal inner space; and a terminal cantilever comprising a cantilever connecting end, a cantilever non-connecting end and a cantilever locking structure, wherein the terminal cantilever is connected to the terminal body at the cantilever connecting end, and the cantilever locking structure is disposed at the cantilever non-connecting end; wherein, the terminal body is allowed to be inserted into the core insertion passage, and the terminal cantilever is allowed to be deformable on the terminal body, so as to lock the cantilever locking structure to the core locking structure; and the terminal restricting structure is located between the terminal cantilever and the terminal notch structure and is configured to restrict the deformation degree of the terminal cantilever, so as to prevent the cantilever locking structure from falling into the terminal inner space via the terminal notch structure and from affecting the locking between the cantilever locking structure and the core locking structure.

Preferably, the electrical connector said above, wherein the insulating core further comprises a core abutting structure, the core insertion passage comprises a core insertion passage locking section, and the terminal body further comprises a terminal abutting structure, wherein when the terminal body is inserted into the core insertion passage, the cantilever locking structure is locked to the core locking structure at the core insertion passage locking section, and the terminal abutting structure is configured to abut the insulating core, so as to prevent the cantilever locking structure from being disengaged from the core insertion passage locking section.

Preferably, the electrical connector said above, wherein the terminal body has two opposite sides, which are a terminal locking side and a terminal non-locking side, respectively, wherein the cantilever locking structure is located at the terminal locking side, and the terminal abutting structure is located at the terminal non-locking side.

Additionally, this application further provides a conductive terminal configured for use with an insulating core, the conductive terminal comprising: a terminal body comprising a terminal restricting structure; and a terminal cantilever comprising a cantilever connecting end, a cantilever non-connecting end and a cantilever locking structure, wherein the terminal cantilever is connected to the terminal body at the cantilever connecting end, and the cantilever locking structure is disposed at the cantilever non-connecting end, allowing the terminal cantilever to be deformable on the terminal body to lock the cantilever locking structure to the insulating core at a locking height; wherein, the terminal restricting structure is configured to restrict the deformation degree of the terminal cantilever, so as to prevent the cantilever locking structure from moving below the locking height and from affecting its locking to the insulating core.

Preferably, the conductive terminal said above, wherein the terminal body has two opposite sides, which are a terminal locking side and a terminal non-locking side, respectively, and the terminal body further comprises a terminal seam structure, wherein the cantilever locking structure is located at the terminal locking side, and the terminal seam structure is located at the terminal non-locking side.

Preferably, the conductive terminal said above, wherein the terminal body has two opposite sides, which are a terminal locking side and a terminal non-locking side, and the terminal body comprises a terminal abutting structure, wherein the cantilever locking structure is located at the terminal locking side, the terminal abutting structure is located at the terminal non-locking side, and the terminal abutting structure is configured to abut the insulating core, so as to prevent the locking between the cantilever locking structure and the insulating core from being released.

Additionally, this application further provides an electrical connector comprising: an insulating core comprising a core insertion passage and a core locking structure; and a conductive terminal comprising: a terminal body comprising a terminal restricting structure; and a terminal cantilever comprising a cantilever connecting end, a cantilever non-connecting end and a cantilever locking structure, wherein the terminal cantilever is connected to the terminal body at the cantilever connecting end, and the cantilever locking structure is disposed at the cantilever non-connecting end; wherein, the terminal body is allowed to be inserted into the core insertion passage, and the terminal cantilever is allowed to be deformable on the terminal body, so as to lock the cantilever locking structure to the core locking structure at a locking height; and the terminal restricting structure is configured to restrict the deformation degree of the terminal cantilever, so as to prevent the cantilever locking structure from moving below the locking height and from affecting its locking to the core locking structure.

Preferably, the electrical connector said above, wherein the insulating core further comprises a core abutting structure, the core insertion passage comprises a core insertion passage locking section, and the terminal body further comprises a terminal abutting structure, wherein when the terminal body is inserted into the core insertion passage, the cantilever locking structure is locked to the core locking structure at the core insertion passage locking section, and the terminal abutting structure is configured to abut the insulating core, so as to prevent the cantilever locking structure from being disengaged from the core insertion passage locking section.

Preferably, the electrical connector said above, wherein the terminal body has two opposite sides, which are respectively a terminal locking side and a terminal non-locking side, wherein the cantilever locking structure is located at the terminal locking side, and the terminal abutting structure is located at the terminal non-locking side.

An electrical connector and a conductive terminal thereof are provided, wherein the conductive terminal is capable of being equipped with an insulation core to form the electrical connector. The conductive terminal comprises a terminal body and a terminal cantilever. The terminal cantilever can deform to lock onto the insulation core, and the terminal body can limit the degree of deformation of the terminal cantilever to prevent the terminal cantilever from undergoing excessive deformation during locking with the insulation core, thereby solving the problem of poor locking between miniaturized conductive terminals and insulation cores, and further improving the reliability of the electrical connector equipped with miniaturized conductive terminals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of the electrical connector according to an embodiment of the present application.

FIG. 2 is a perspective schematic view of the conductive terminal according to an embodiment of the present application.

FIG. 3 is a left-side schematic view of the conductive terminal according to an embodiment of the present application.

FIG. 4 is a rear schematic view of the conductive terminal according to an embodiment of the present application.

FIG. 5 is a sectional schematic view of a part of the conductive terminal shown in FIG. 4, taken along line AA.

FIG. 6 is a sectional schematic view of a part of the conductive terminal shown in FIG. 4, taken along line A′A′.

FIG. 7 is a sectional schematic view of a part of the conductive terminal shown in FIG. 4, taken along line A″A″.

FIG. 8 is a sectional schematic view of a part of the conductive terminal shown in FIG. 4, taken along line A″′A″′.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

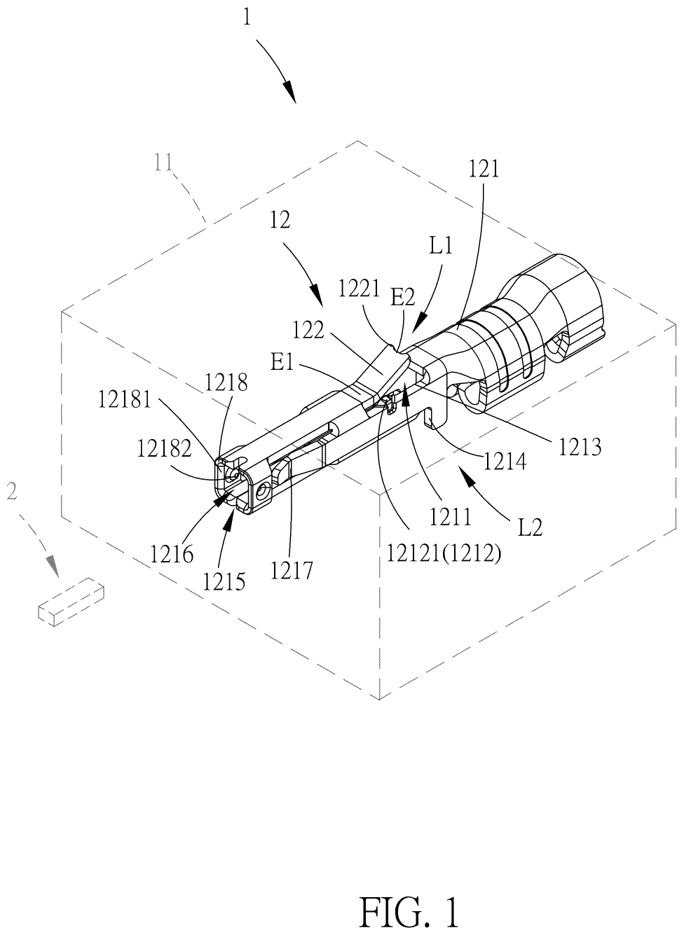

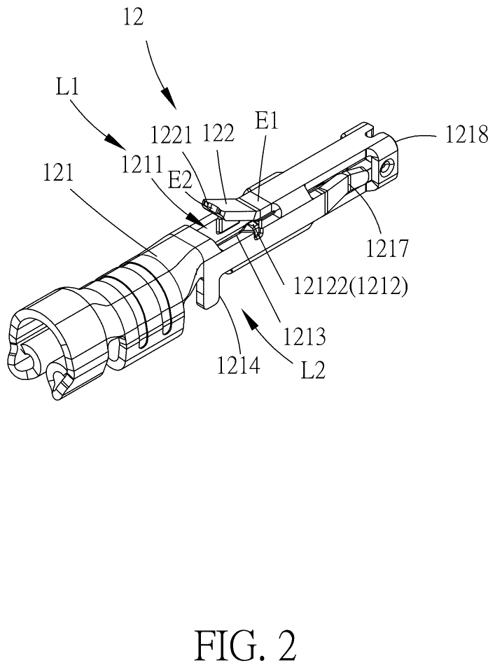

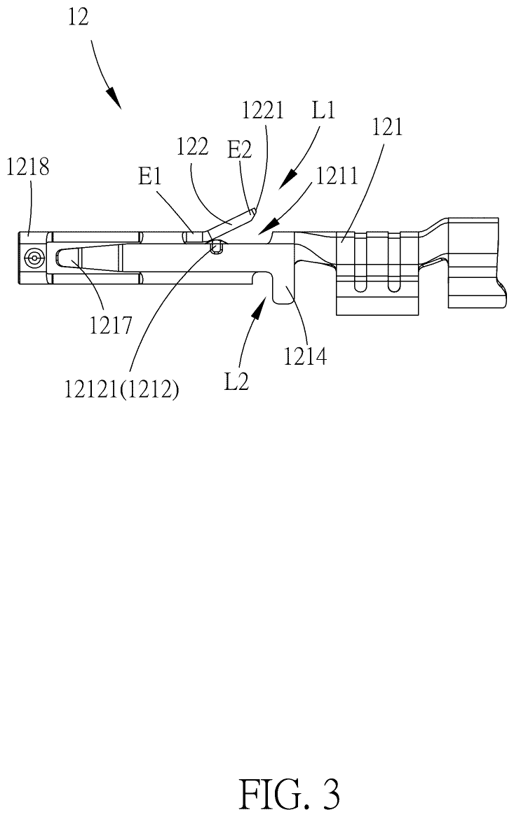

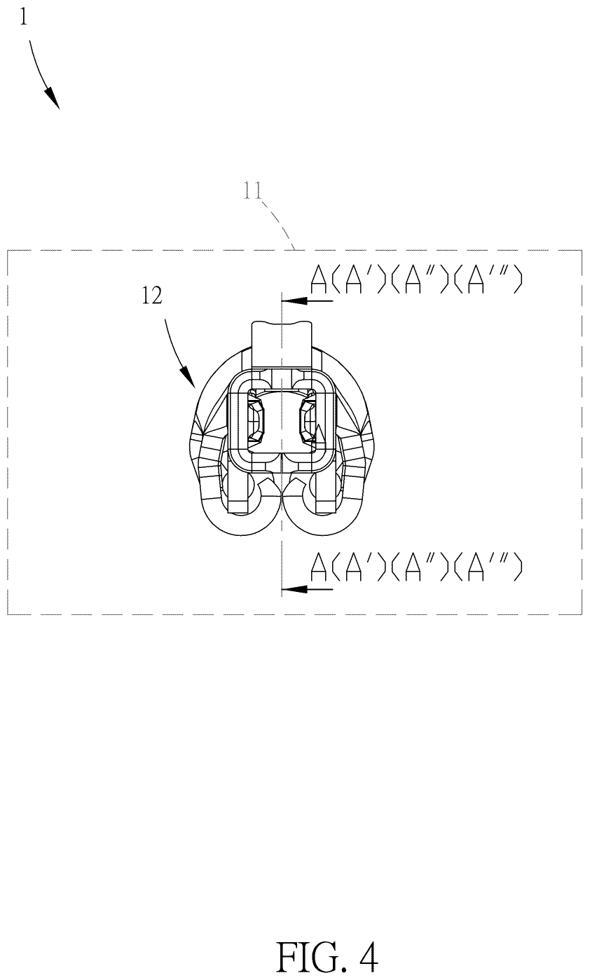

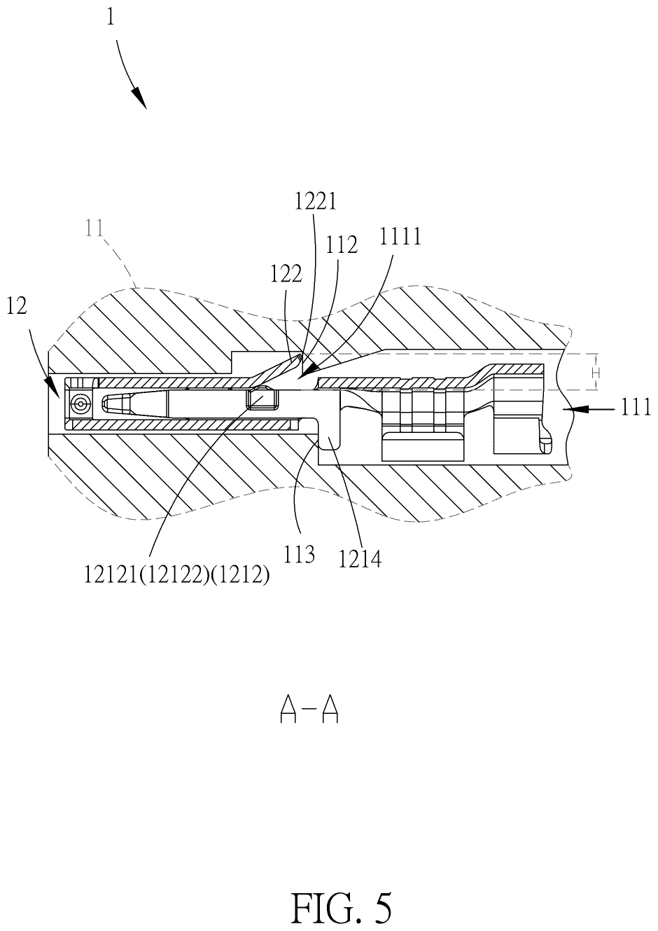

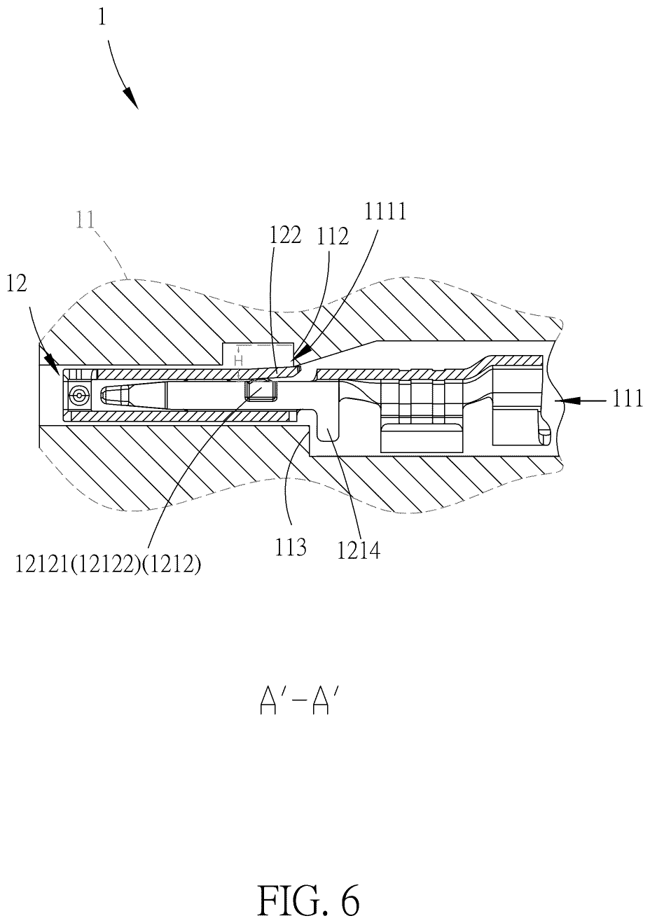

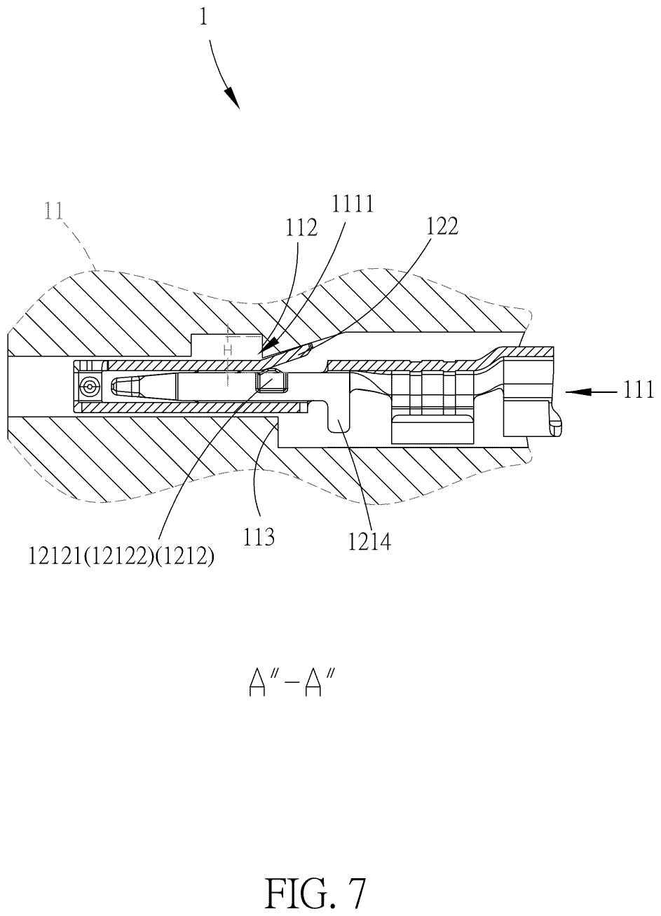

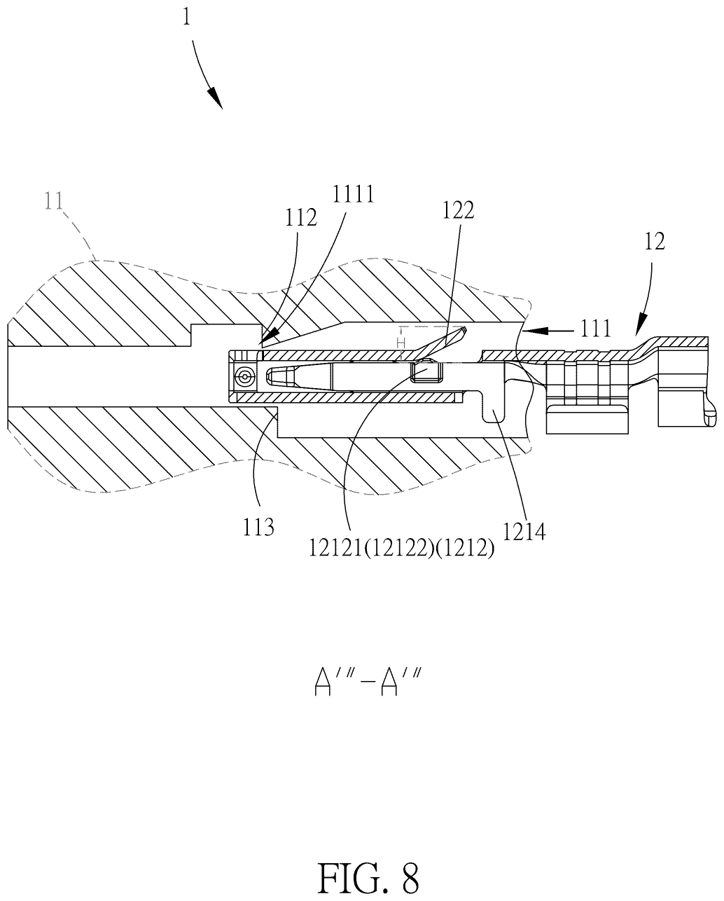

For a detailed description of the embodiments disclosed in the present application, please refer to FIGS. 1 to 8.

The present application provides a conductive terminal capable of enabling a conductive component to mate therewith for signal transmission in an electronic product. The conductive terminal may be disposed in an electrical connector, and the conductive component may be inserted into the electrical connector to mate with the conductive terminal disposed therein for electrical signal transmission. The conductive component may be a component in the form of a conductive terminal or an electrical connector.

In the embodiment shown in FIGS. 1 to 8 of the present application, at least one electrical connector 1 is disclosed. The electrical connector 1 comprises an insulation core 11 and a conductive terminal 12. It should be noted that the conductive terminal 12 may optionally be integrally formed by bending and cutting a metal sheet.

Regarding the insulation core 11, the insulation core 11 comprises a core insertion passage 111, a core locking structure 112, and a core abutting structure 113. The core insertion passage 111 comprises a core insertion passage locking section 1111.

Regarding the conductive terminal 12, the conductive terminal 12 comprises a terminal body 121 and a terminal cantilever 122.

As for the terminal body 121, the terminal body 121 comprises a terminal internal space 1211, a terminal limiting structure 1212, a terminal notch structure 1213, a terminal abutting structure 1214, a terminal seam structure 1215, a terminal mating passage 1216, a terminal mating structure 1217, and a terminal guiding frame 1218.

As for the terminal cantilever 122, the terminal cantilever 122 comprises a cantilever connecting end E1 (i.e., a non-free end), a cantilever non-connecting end E2 (i.e., a free end), and a cantilever locking structure 1221. The terminal cantilever 122 is connected to the terminal body 121 at the cantilever connecting end E1, and the cantilever locking structure 1221 is located at the cantilever non-connecting end E2, namely, at the free end of the terminal cantilever 122.

In the above embodiment, the terminal guiding frame 1218 comprises a terminal frame guiding structure 12181 and a discharge contact structure 12182. It should be noted that the terminal frame guiding structure 12181 can guide the conductive component 2 to enter the terminal internal space 1211 through the terminal mating passage 1216 and mate with the terminal mating structure 1217. The discharge contact structure 12182, which may be a protrusion adapted to provide electrostatic discharge by the tip effect, can contact the conductive component 2 during the guiding process by the terminal frame guiding structure 12181, and provide discharge to the conductive component 2. The discharge contact structure 12182 contacts the conductive component 2 earlier than the terminal mating structure 1217 mates with the conductive component 2, thereby effectively preventing static electricity from intruding into the electronic product through the conductive terminal 12 and damaging the internal circuit of the electronic product.

In the above embodiment, the opposite sides of the terminal body 121 are respectively a terminal locking side L1 and a terminal non-locking side L2, wherein the cantilever locking structure 1221 is located on the terminal locking side L1, and the terminal abutting structure 1214 and the terminal seam structure 1215 are located on the terminal non-locking side L2. In this manner, it is possible to prevent the terminal abutting structure 1214 and the terminal seam structure 1215 from weakening the structural strength of the cantilever locking structure 1221, thereby enhancing the overall structural strength of the conductive terminal 12 and preventing local deformation of the conductive terminal 12, thus improving the reliability of the electrical connector equipped with the conductive terminal 12.

The terminal notch structure 1213 is in continuity with the terminal internal space 1211, and the cantilever locking structure 1221 is located above the terminal notch structure 1213. The terminal body 121 can be inserted into the core insertion passage 111. When the terminal body 121 is inserted into the core insertion passage 111, the insulation core 11 can force the terminal cantilever 122 to deform on the terminal body 121, thereby allowing the cantilever locking structure 1221 to lock onto the core locking structure 112 at a locking height H in the core insertion passage locking section 1111. At this time, the terminal abutting structure 1214 can abut against the insulation core 11 to prevent the cantilever locking structure 1221 from leaving the core insertion passage locking section 1111 and releasing its locked engagement with the insulation core 11.

It should be noted that the terminal limiting structure 1212 is located between the terminal cantilever 122 and the terminal notch structure 1213, so as to limit the degree of deformation of the terminal cantilever 122, thereby preventing the cantilever locking structure 1221 from falling into the terminal internal space 1211 through the terminal notch structure 1213, or preventing the cantilever locking structure 1221 from dropping below the locking height H, which would affect the locking of the cantilever locking structure 1221 with the core locking structure 112. Accordingly, the terminal limiting structure 1212 can prevent excessive deformation of the terminal cantilever 122 during the engagement with the insulation core 11, thereby solving the issue of poor locking between miniaturized conductive terminals and insulation cores, and improving the reliability of electrical connectors equipped with miniaturized conductive terminals.

Optionally, the terminal limiting structure 1212 may be a protruding structure on the terminal body 121 that limits the deformation of the terminal cantilever 122. Additionally, optionally, the terminal limiting structure 1212 may have a first terminal limiting sub-structure 12121 and a second terminal limiting sub-structure 12122, wherein the first terminal limiting sub-structure 12121 and the second terminal limiting sub-structure 12122 are located on opposite sides of the terminal notch structure 1213, respectively limiting the deformation of the two sides of the cantilever locking structure 1221, thereby preventing the two sides of the cantilever locking structure 1221 from falling into the terminal internal space 1211 through the terminal notch structure 1213 or dropping below the locking height H.

It should be noted that in the above embodiment, some of the aforementioned components may be omitted. For example, in the present application, the conductive terminal may comprise only: a terminal body and a terminal cantilever. The terminal body comprises a terminal internal space, a terminal limiting structure, and a terminal notch structure, wherein the terminal notch structure is in continuity with the terminal internal space. The terminal cantilever comprises a cantilever connecting end, a cantilever non-connecting end, and a cantilever locking structure, wherein the terminal cantilever is connected to the terminal body at the cantilever connecting end, and the cantilever locking structure is located at the cantilever non-connecting end, such that the terminal cantilever can deform on the terminal body to allow the cantilever locking structure to lock onto the insulation core; wherein the terminal limiting structure is located between the terminal cantilever and the terminal notch structure to limit the degree of deformation of the terminal cantilever, thereby preventing the cantilever locking structure from falling into the terminal internal space through the terminal notch structure and affecting the locking of the cantilever locking structure with the insulation core.

In addition, in the present application, the electrical connector may comprise only: an insulation core and a conductive terminal. The insulation core comprises a core insertion passage and a core locking structure. The conductive terminal comprises a terminal body and a terminal cantilever. The terminal body comprises a terminal internal space, a terminal limiting structure, and a terminal notch structure, wherein the terminal notch structure is in continuity with the terminal internal space. The terminal cantilever comprises a cantilever connecting end, a cantilever non-connecting end, and a cantilever locking structure, wherein the terminal cantilever is connected to the terminal body at the cantilever connecting end, and the cantilever locking structure is located at the cantilever non-connecting end; wherein the terminal body can be inserted into the core insertion passage to allow the terminal cantilever to deform on the terminal body and enable the cantilever locking structure to lock onto the core locking structure; and the terminal limiting structure is located between the terminal cantilever and the terminal notch structure to limit the degree of deformation of the terminal cantilever, thereby preventing the cantilever locking structure from falling into the terminal internal space and affecting the locking with the core locking structure.

Furthermore, in the present application, the conductive terminal may comprise only: a terminal body and a terminal cantilever. The terminal body comprises a terminal limiting structure. The terminal cantilever comprises a cantilever connecting end, a cantilever non-connecting end, and a cantilever locking structure, wherein the terminal cantilever is connected to the terminal body at the cantilever connecting end, and the cantilever locking structure is located at the cantilever non-connecting end, such that the terminal cantilever can deform on the terminal body to allow the cantilever locking structure to lock onto the insulation core at the locking height; wherein the terminal limiting structure can limit the degree of deformation of the terminal cantilever to prevent the cantilever locking structure from dropping below the locking height and affecting the locking onto the insulation core.

Additionally, in the present application, the electrical connector may comprise only: an insulation core and a conductive terminal. The insulation core comprises a core insertion passage and a core locking structure. The conductive terminal comprises a terminal body and a terminal cantilever. The terminal body comprises a terminal limiting structure. The terminal cantilever comprises a cantilever connecting end, a cantilever non-connecting end, and a cantilever locking structure, wherein the terminal cantilever is connected to the terminal body at the cantilever connecting end, and the cantilever locking structure is located at the cantilever non-connecting end; wherein the terminal body can be inserted into the core insertion passage to allow the terminal cantilever to deform on the terminal body and enable the cantilever locking structure to lock onto the core locking structure at the locking height; and the terminal limiting structure can limit the degree of deformation of the terminal cantilever to prevent the cantilever locking structure from dropping below the locking height and affecting the locking onto the core locking structure.

In summary, the present application provides an electrical connector and a conductive terminal thereof. The conductive terminal can be mated with an insulation core to form the electrical connector. The conductive terminal comprises a terminal body and a terminal cantilever. The terminal cantilever can deform to lock onto the insulation core, and the terminal body can limit the degree of deformation of the terminal cantilever, thereby preventing excessive deformation of the terminal cantilever during locking with the insulation core, solving the problem of poor locking between miniaturized conductive terminals and insulation cores, and improving the reliability of electrical connectors equipped with miniaturized conductive terminals.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A conductive terminal configured for use with an insulating core, the conductive terminal comprising:
a terminal body comprising a terminal inner space, a terminal restricting structure, and a terminal notch structure, wherein the terminal notch structure communicates with the terminal inner space; and
a terminal cantilever comprising a cantilever connecting end, a cantilever non-connecting end and a cantilever locking structure, wherein the terminal cantilever is connected to the terminal body at the cantilever connecting end, and the cantilever locking structure is disposed at the cantilever non-connecting end, allowing the terminal cantilever to be deformable on the terminal body to lock the cantilever locking structure to the insulating core;
wherein the terminal restricting structure is located between the terminal cantilever and the terminal notch structure and is configured to restrict the deformation degree of the terminal cantilever, so as to prevent the cantilever locking structure from falling into the terminal inner space via the terminal notch structure and from affecting the locking between the cantilever locking structure and the insulating core.

2. The conductive terminal of claim 1, wherein the terminal restricting structure is a protruding structure on the terminal body.

3. The conductive terminal of claim 1, wherein the terminal restricting structure comprises a first terminal restricting substructure and a second terminal restricting substructure, and the first terminal restricting substructure and the second terminal restricting substructure are respectively located on two sides of the terminal notch structure and configured to respectively restrict the deformation degree of two sides of the cantilever locking structure.

4. The conductive terminal of claim 1, wherein the cantilever locking structure is located above the terminal notch structure.

5. The conductive terminal of claim 1, wherein the terminal body has two opposite sides, which are a terminal locking side and a terminal non-locking side, respectively, and the terminal body further comprises a terminal seam structure, wherein the cantilever locking structure is located at the terminal locking side, and the terminal seam structure is located at the terminal non-locking side.

6. The conductive terminal of claim 1, wherein the terminal body has two opposite sides, which are a terminal locking side and a terminal non-locking side, respectively, and the terminal body further comprises a terminal abutting structure, wherein the cantilever locking structure is located at the terminal locking side, and the terminal abutting structure is located at the terminal non-locking side and is configured to abut the insulating core, so as to prevent the locking between the cantilever locking structure and the insulating core from being released.

7. The conductive terminal of claim 1, further configured for mating with a conductive component, wherein the terminal body further comprises a terminal mating structure, a terminal frame-shaped guiding body and a terminal mating passage, and the terminal frame-shaped guiding body comprises a terminal frame-shaped guiding structure, wherein,
the terminal frame-shaped guiding structure is configured to guide the conductive component through the terminal mating passage into the terminal inner space to mate with the terminal mating structure.

8. The conductive terminal of claim 7, wherein the terminal frame-shaped guiding body further comprises a discharge contact structure, and when the terminal frame-shaped guiding structure is guiding the conductive component, the discharge contact structure is configured to contact the conductive component to provide electrostatic discharge for the conductive component, wherein the timing of the discharge contact structure contacting the conductive component is earlier than the timing of the terminal mating structure mating with the conductive component.

9. The conductive terminal of claim 8, wherein the discharge contact structure is a protruding structure.

10. An electrical connector comprising:
an insulating core comprising a core insertion passage and a core locking structure; and
a conductive terminal comprising:
a terminal body comprising a terminal inner space, a terminal restricting structure, and a terminal notch structure, wherein the terminal notch structure communicates with the terminal inner space; and
a terminal cantilever comprising a cantilever connecting end, a cantilever non-connecting end and a cantilever locking structure, wherein the terminal cantilever is connected to the terminal body at the cantilever connecting end, and the cantilever locking structure is disposed at the cantilever non-connecting end; wherein,
the terminal body is allowed to be inserted into the core insertion passage, and the terminal cantilever is allowed to be deformable on the terminal body, so as to lock the cantilever locking structure to the core locking structure; and
the terminal restricting structure is located between the terminal cantilever and the terminal notch structure and is configured to restrict the deformation degree of the terminal cantilever, so as to prevent the cantilever locking structure from falling into the terminal inner space via the terminal notch structure and from affecting the locking between the cantilever locking structure and the core locking structure.

11. The electrical connector of claim 10, wherein the insulating core further comprises a core abutting structure, the core insertion passage comprises a core insertion passage locking section, and the terminal body further comprises a terminal abutting structure, wherein when the terminal body is inserted into the core insertion passage, the cantilever locking structure is locked to the core locking structure at the core insertion passage locking section, and the terminal abutting structure is configured to abut the insulating core, so as to prevent the cantilever locking structure from being disengaged from the core insertion passage locking section.

12. The electrical connector of claim 11, wherein the terminal body has two opposite sides, which are a terminal locking side and a terminal non-locking side, respectively, wherein the cantilever locking structure is located at the terminal locking side, and the terminal abutting structure is located at the terminal non-locking side.

13. A conductive terminal configured for use with an insulating core, the conductive terminal comprising:
a terminal body comprising a terminal restricting structure; and
a terminal cantilever comprising a cantilever connecting end, a cantilever non-connecting end and a cantilever locking structure, wherein the terminal cantilever is connected to the terminal body at the cantilever connecting end, and the cantilever locking structure is disposed at the cantilever non-connecting end, allowing the terminal cantilever to be deformable on the terminal body to lock the cantilever locking structure to the insulating core at a locking height; wherein,
the terminal restricting structure is configured to restrict the deformation degree of the terminal cantilever, so as to prevent the cantilever locking structure from moving below the locking height and from affecting its locking to the insulating core.

14. The conductive terminal of claim 13, wherein the terminal body has two opposite sides, which are a terminal locking side and a terminal non-locking side, respectively, and the terminal body further comprises a terminal seam structure, wherein the cantilever locking structure is located at the terminal locking side, and the terminal seam structure is located at the terminal non-locking side.

15. The conductive terminal of claim 13, wherein the terminal body has two opposite sides, which are a terminal locking side and a terminal non-locking side, and the terminal body comprises a terminal abutting structure, wherein the cantilever locking structure is located at the terminal locking side, the terminal abutting structure is located at the terminal non-locking side, and the terminal abutting structure is configured to abut the insulating core, so as to prevent the locking between the cantilever locking structure and the insulating core from being released.

16. An electrical connector comprising:
an insulating core comprising a core insertion passage and a core locking structure; and
a conductive terminal comprising:
a terminal body comprising a terminal restricting structure; and
a terminal cantilever comprising a cantilever connecting end, a cantilever non-connecting end and a cantilever locking structure, wherein the terminal cantilever is connected to the terminal body at the cantilever connecting end, and the cantilever locking structure is disposed at the cantilever non-connecting end; wherein, the terminal body is allowed to be inserted into the core insertion passage, and the terminal cantilever is allowed to be deformable on the terminal body, so as to lock the cantilever locking structure to the core locking structure at a locking height; and
the terminal restricting structure is configured to restrict the deformation degree of the terminal cantilever, so as to prevent the cantilever locking structure from moving below the locking height and from affecting its locking to the core locking structure.

17. The electrical connector of claim 16, wherein the insulating core further comprises a core abutting structure, the core insertion passage comprises a core insertion passage locking section, and the terminal body further comprises a terminal abutting structure, wherein when the terminal body is inserted into the core insertion passage, the cantilever locking structure is locked to the core locking structure at the core insertion passage locking section, and the terminal abutting structure is configured to abut the insulating core, so as to prevent the cantilever locking structure from being disengaged from the core insertion passage locking section.

18. The electrical connector of claim 17, wherein the terminal body has two opposite sides, which are respectively a terminal locking side and a terminal non-locking side, wherein the cantilever locking structure is located at the terminal locking side, and the terminal abutting structure is located at the terminal non-locking side.
